(19) United States
(12) Patent Application Publication
(10) Pub. No.: US 2003/0158761 A1
(43) Pub. Date: Aug. 21, 2003

(54) Method of providing lodging and vehicle rentals for travelers

(76) Inventor: Hugh W. Johnston, Gastonia, NC (US)

Correspondence Address: BACON & THOMAS, PLLC, 625 SLATERS LANE, FOURTH FLOOR, ALEXANDRIA, VA, 22314

(21) Appl. No.: 10/075,384

(22) Filed: Feb. 15, 2002

(51) Int. Cl. G06F 17/60

(52) U.S. Cl. 705/5; 705/1

(57) ABSTRACT

A method of providing lodging and vehicle rentals for travelers is carried out by providing both the lodging and the vehicle rentals at a same location through a single vendor. A common shuttle is provided to carry travelers from a point of arrival to the lodging location in a single trip. The lodging location includes a room to be rented and a parking space associated with the room, with a rental vehicle parked in the parking space. Access to the room may be gained by presenting a payment card to a reader in or adjacent to a door of the room, while access to the vehicle may be acquired through keys left in the room.

### BACKGROUND OF THE INVENTION

1. Field of the Invention

This invention relates to methods of providing lodging and vehicle rentals for travelers, and in particular to methods in which both lodging and vehicle rentals (also referred to as “car” rentals) are provided by a single vendor at a same location using a common registration and payment system.

2. Description of Related Art

Currently, lodging and vehicle rentals are provided by separate vendors. This is inconvenient for travelers, who must make register separately at each vendor and make time-consuming trips from one vendor to the other, and also costly for vendors, who must duplicate services and expenses such as labor costs, rents, and the cost of providing customer transportation (i.e., vans or shuttle buses).

Atypical method of providing lodging and vehicle rentals for a traveler arriving with luggage at an airport or other port of entry or common carrier terminus or arrival point, is illustrated in FIG. 1. First, the traveler must load his or her luggage in a shuttle bus or van (step 10) and ride to the business location of the rental vehicle (rental car) vendor (step 20). The traveler must then unload the luggage (step 30) and check-in with the rental car vendor (step 40). Even if the traveler has made advance reservations, the traveler must in most cases enter a building in order to present himself or herself to an agent of the vendor, show identification, answer questions, fill-out, verify, or initial various forms, and make a deposit, although some vendors have express check-in procedures that permit the traveler to proceed directly to the rental car with minimal paperwork. Often, the check-in procedure entails waiting in line, during which time the traveler must keep an eye on his or her luggage, followed by a relatively long walk to the parking place of the vehicle being rented.

Once the traveler has acquired the rental vehicle and loaded the luggage (step 50), the traveler must drive from the location of the rental car vendor to a place of lodging such as a hotel or motel (step 60). After finding a temporary place to the park the vehicle, the traveler must check-in at the place of lodging (step 70), which again may involve waiting in line, paperwork, and payment of a deposit. The traveler must then, typically, find a final parking space for the rental vehicle (step 80) and, either before or after moving the vehicle to the final parking space, unload the luggage (step 90), and carry the luggage or have the luggage carried to the room being rented (step 100).

When the traveler is ready to depart, an equally arduous and time-consuming procedure must be followed, even though the traveler is often under critical time constraints because of the need to catch a return flight. First, the traveler must load the luggage in the vehicle (step 110) and check-out of the hotel (step 120), not necessarily in that order. Check-out again may involve waiting in line and paperwork, as well as verification of charges and payment. The traveler then must drive back to the place of business of the rental car vendor (step 130), which often involves a search for a gas station near the rental car vendor to avoid gasoline charges imposed by the vendor, followed by yet another step of unloading the luggage (step 140). The traveler must then turn in the car (step 150), which may involve carrying the luggage to a building and waiting for a clerk to complete the paperwork and take payment, or waiting for personnel to complete an expedited check-out procedure at the vehicle drop-off point. Following vehicle turn-in and/or check-out, the traveler must wait for a shuttle bus or van, load the luggage in the shuttle (step 160), ride the shuttle to the airport (step 170), and unload the luggage from the shuttle (step 180) before proceeding to airline check-in and security.

In all, the conventional method involves four luggage loads, four luggage unloads, two check-ins, two check-outs, and round-trip travel from the airport to the rental car vendor's place of business and from the rental car vendor's place of business to the place of lodging. This has long been a source of frustration for travelers and a source of unnecessary costs to the vendors, the costs including the costs of dual check-in and reservations personnel, real estate expenses and fees for rental of airport property, shuttle personnel and expenses, costs associated with parking cars and driving them to servicing and cleaning locations, and so forth. Of course, while the frustration involved in separately renting a car and checking into a place of lodging has long been recognized, the source of the frustration and the costs involved, namely the separate provision of rental car and lodging services, has not been recognized. Hertz, Avis, and others continue to deal exclusively in car rentals, while Hilton, Holiday Inn continue to expect customers to travel first to the car rental agency before making their way, bleary-eyed, to the hotel.

### SUMMARY OF THE INVENTION

It is accordingly a first objective of the invention to provide a method of providing lodging and rental vehicles that enables the traveler to avoid having to make separate trips to a rental car vendor in order to acquire and turn-in a rental vehicle, thereby eliminating the need to load and unload luggage at the rental car vendor's location, to separately check-in and check-out at the rental car vendor's location and at the place of lodging, and to make separate payments, while saving the traveler significant time and energy that may be used to shorten the trip or to make the trip more productive.

It is a second objective to provide a method of providing lodging and a rental vehicle to a traveler that, from the standpoint of vendors, enables enhanced efficiency by eliminating un-necessary costs resulting from duplication of labor, equipment, and space related to reservations, check-in, and check-out, as well as costs of locating near or at an airport, and so forth.

It is a third objective of the invention not only to eliminate duplication of personnel and equipment necessary to carry out registration, check-in, and the like, but to eliminate such personnel entirely, as well as the inconvenience and much of the equipment and space associated with such activities.

These objectives are achieved, in accordance with the principles of the invention, by a method of providing lodging and rental vehicles in which both lodging and the rental vehicles are provided by a single vendor at a same location.

According to a first aspect of the invention, the location at which lodging and rental vehicles are provided includes both rooms and parking spaces associated with respective rooms, and the method comprises the steps of: (1) providing a vehicle in a parking space associated with a room; (2) accepting a common reservation for said room and said vehicle; (3) providing transportation from a common carrier arrival point to said lodging; (4) accepting payment at said room for both said room and said vehicle; and (5) granting access to said room and said vehicle following said payment.

According to another aspect of the invention, the method of the invention includes the step of providing lodging and a vehicle rental at a single location accessible to a traveler by a single shuttle ride irrespective of the method of reservation and payment.

According to yet another aspect of the invention, the method of the invention includes the steps of payment for both a room and a vehicle parked in a parking space associated with said room, irrespective of the method of reservation and whether transportation is providing to the room.

According to further aspects of the invention, the invention provides a method of operating a vehicle rental agency that includes the step of storing and maintaining rental vehicles, during periods between rentals, in parking spaces associated with hotel or motel rooms, and/or a method of operating lodging that includes the step of providing, in parking spaces associated with rooms for rent, vehicles that are rented upon rental of said rooms.

Finally, according to a still further aspect of the invention, authorization to use the vehicle is preferably determined at the time of reservation. According to this aspect of the invention, the traveler at the time of reservation provides not only a credit card number, but also a valid drivers license number and state, together with appropriate expiration dates. Upon verification, the authorization papers are placed in an appropriate location within the room, or may be sent to the traveler in advance by mail, e-mail, or courier together with confirmation of the registration. In addition, any driver leaving the place of lodging/rental car provider will preferably need to show identification, including a valid driver's license, to a security guard who will then confirm that the driver has paid and is authorized to operate the vehicle.

As a result of the above-described aspects of the invention, the traveler may use the following simple procedure to obtain lodging and a rental car: (1) Upon arrival at the airport, the traveler contacts a single vendor, which will typically provide a shuttle bus or van service to transport the traveler from the airport to the vendor's location (although it is within the scope of at least one aspect of the invention for the vendor to have premises at the airport itself so long as the location in question includes rooms, a parking space associated with each room, and a rental vehicle in the parking space). (2) The traveler proceeds to the vendor's location and to one of the rooms, the door to which includes or is adjacent to an automated check-in/check-out unit that includes a card or token reader and that is connected to a central computer. (3) The traveler inserts a payment card or token into the reader, the reader reads the card, and the automated check-in/check-out unit, with the assistance of the central computer, verifies the traveler's credit or ability to pay, charges the credit card or debits an account the cost of the room and rental vehicle, and unlocks the door to the room. (4) In addition to being granted access to the room, the traveler may receive the key to the rental vehicle from a receptacle in the room, or from the automated check-in/check-out unit, and optionally also receives a written authorization to use the rental vehicle. (5) The traveler then has free use of the rental car, after verification of identity by a security guard, until the end of the rental period, at which time the traveler simply needs to return the rental car to the parking space associated with the room and place the key back in the receptacle, the receptacle retaining the key and causing the automated check-in/check-out unit to print out a final statement of charges from the vendor (or the traveler may simply place the key back in the room and/or use a payment card, button on the check-in/check-out unit, menu selection on a display screen, or the like to initiate print-out of the final statement). (6) Finally, the traveler may use the final statement of charges or a payment card or token to access the shuttle bus or van provided by the vendor and be transported directly back to the airport.

These and other features and aspects of the invention will become more apparent from the following description of various preferred embodiments of the invention with reference to the accompanying drawings.

### BRIEF DESCRIPTION OF THE DRAWINGS

FIG. 1 is a flowchart of a conventional method of providing lodging and a rental vehicle.

FIG. 2 is a flowchart of a method of providing lodging and a rental vehicle in accordance with the principles of a preferred embodiment of the invention, from the traveler's point of view.

FIG. 3 is a flowchart of the method of FIG. 2, from the vendor's point of view.

### DETAILED DESCRIPTION OF THE PREFERRED EMBODIMENTS

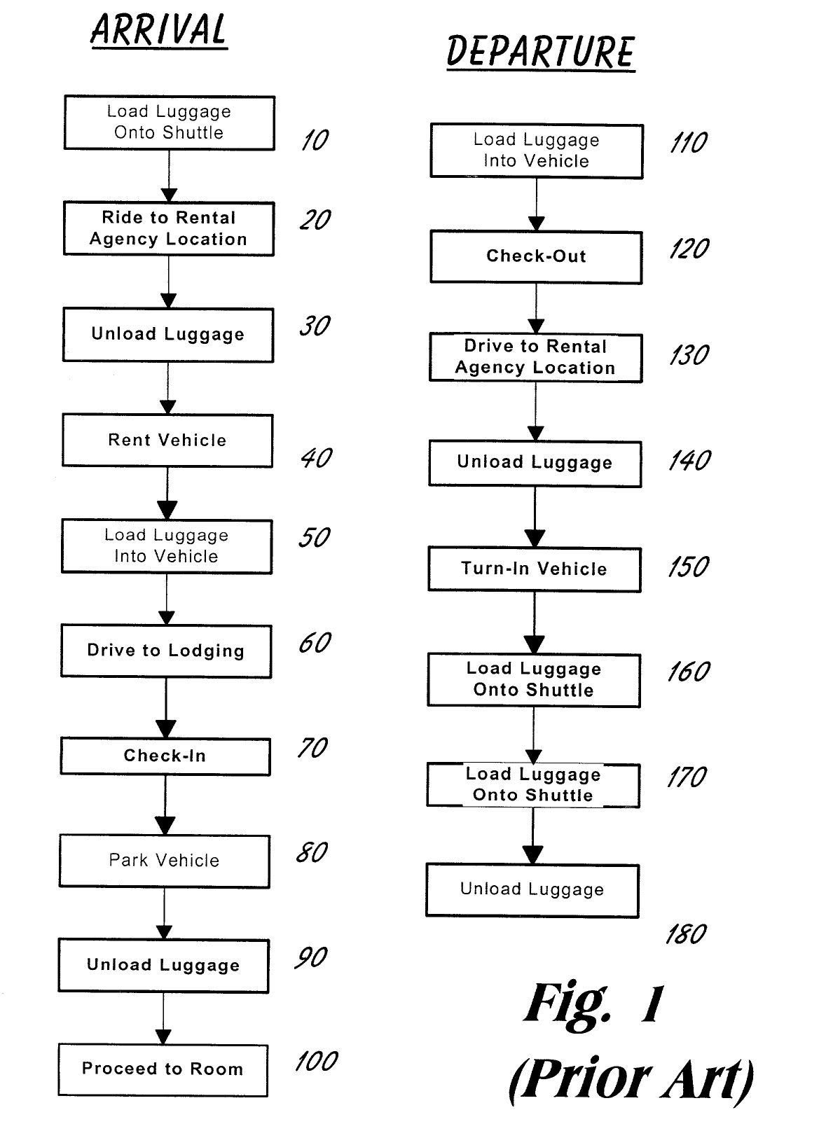

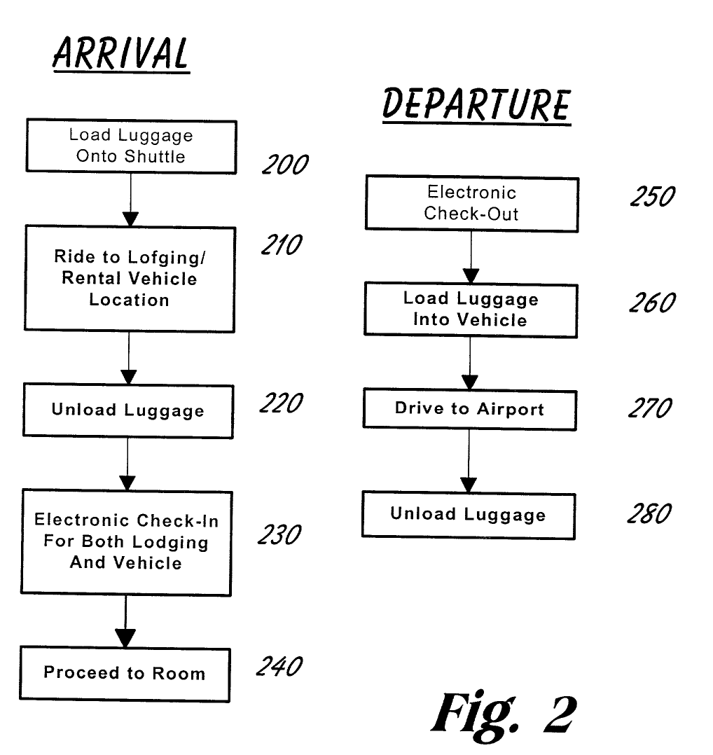

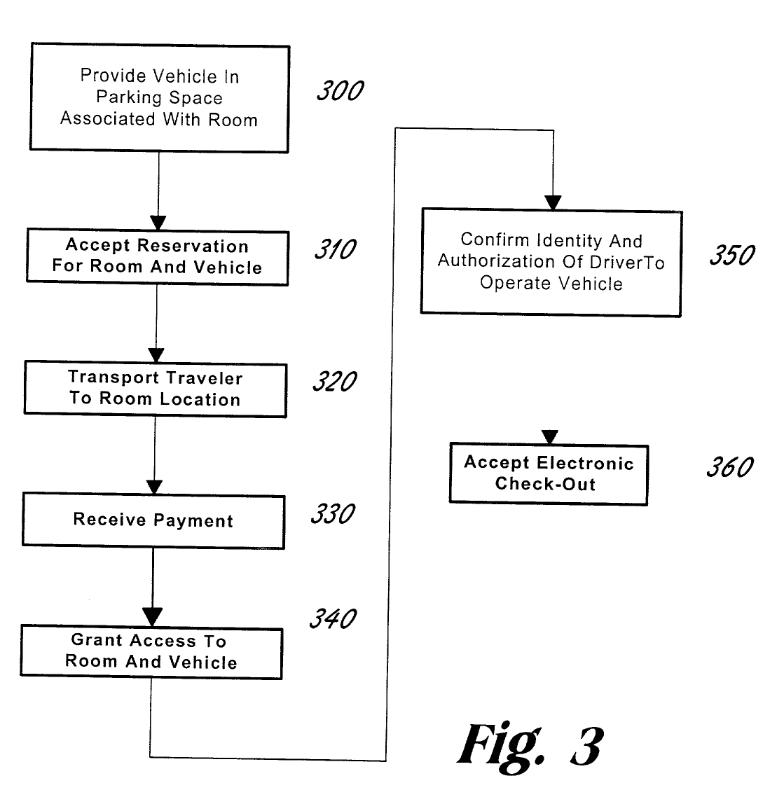

A preferred method of providing lodging and a rental car in accordance with the principles of the invention is illustrated in FIGS. 2 and 3. FIG. 2 illustrates the effects of the preferred method from the point of view of the traveler so that the method of the invention may more easily be compared with the conventional method illustrated in FIG. 1, while FIG. 3 illustrates the steps that must be carried out by the vendor to implement the preferred method.

As illustrated in FIG. 2, for a traveler arriving at an airport with luggage, the method of the invention begins with loading luggage into a shuttle bus or van (step 200), riding the shuttle bus or van to the place of lodging (step 210), unloading the luggage as necessary (step 220), proceeding to the room, and electronically checking-in by presenting an electronic payment card or token to a reader situated in an automated check-in/check-out unit adjacent or in the door of the room, the card reader reading the card, and the automated check-in/check-out unit verifying, with the assistance of a central computer to which it is connected, the traveler's credit or available balance, charging the credit card or appropriate account the cost of the hotel room and rental vehicle, and unlocking the door to the hotel room (step 240). Upon entry into the hotel room, the traveler obtains the key to the rental vehicle from a receptacle in the room, together with a written authorization to use the rental vehicle if not previously provided. Those skilled in the art will notice that this procedure entirely eliminates steps 20, 30, 50, and 80 of the method illustrated in FIG. 1, with consequent savings to the vendor of overhead associated with the eliminated steps.

As also illustrated in FIG. 2, the check-out procedure is equally simple, involving return of the vehicle to its designated parking space, leaving the key in the room and optionally within a designated receptacle within the room or the automated check-in/check-out unit, and the illustrated steps of inserting the payment card into the reader or otherwise indicating a desire to checkout (step 250). The receptacle retains the key and causes the automated check-in/check-out unit to print out a final statement of charges from the vendor. The traveler may use this final statement of charges or a credit/debit/smartcard to access the shuttle bus or van provided by the vendor and be transported directly back to the airport following the step of loading any luggage into the shuttle bus or van (step 260). After riding the shuttle bus or van to the airport (step 270), the traveler simply needs to unload his or her luggage as necessary from the shuttle bus or van (step 280), at which point the traveler is ready to proceed to airline check-in and/or security.

Turning to FIG. 3, the steps to be carried out by the vendor are essentially as follows: First, the vendor must provide a vehicle in a parking space associated with and at substantially the same location as a room for rent (step 300). The vendor then accepts a reservation for the room and vehicle (step 310). For security purposes, authorization to use the vehicle is preferably determined at the time of reservation, the traveler being asked at the time of the reservation to provide not only a credit card number, but also a valid drivers license number and state, together with appropriate expiration dates. Upon verification, the authorization papers may be placed in an appropriate location within the room, or may be sent to the traveler in advance by mail, e-mail, or courier together with confirmation of the registration.

The third step is to transport the traveler to the room (step 320). Typically, this will be by shuttle bus or van, although it is within the scope of the invention to provide other means of transport such as air, water, or rail transport, and even to permit the traveler to reach the location of the room solely on foot. The vendor then must accept payment though the above-described card reader (step 330), grant or enable access to the room and rental vehicle (step 340), confirm the identity and authorization of the traveler as he or she drives away in the rental vehicle (step 350), for example, through the use of exit gate controlled by security guard, provide confirmation of charges when the traveler indicates a desire to check-out (step 360) by, for example, re-inserting his payment card into the card reader, and transport traveler to back to airport (step 370).

In addition to the above-described features, it is within the scope of the invention to include, at the vendor's location, not only a rental vehicle in a parking space adjacent to the room in which the customer is to be lodged, but also any other amenities that may conventionally be provided by places of lodging, including restaurants, swimming pools, lounges, spas, health clubs, laundry machines, and valet or concierge services, as well as additional amenities such as a location of a gasoline station on the premises of the place of lodging/vehicle rental facility, and/or facilities for servicing vehicles in the parking spaces outside the rooms when the vehicles are not being rented to eliminate the need for separate storage and repair areas for the rental vehicles.

The methods of the preferred embodiments have a number of advantages over the prior art. A single reservation and payment is made electronically with a single consolidated vendor for both lodging and vehicle rental, which is simpler and takes less time than making separate reservations with a first vendor for a rental vehicle and with a second vendor for lodging. Furthermore, the traveler only needs to make a single trip to take possession of both the rental vehicle and the place of lodging and, if the traveler has luggage, only needs to load and unload the luggage one time. Further advantages are that the traveler is guaranteed a convenient parking space without the need for a separate parking ticket and payment or authorization, is not required to carry a separate room key, is not required to present himself to a rental agent to obtain authorization papers for the vehicle, is able to obtain a statement of charges and/or receipt from the automated check-in/check-out unit, and is therefore able to check out and proceed directly back to the airport without having to stop by the front desk of the place of lodging and without having to take a detour to the rental agency. In addition, the traveler may conveniently be provided a single number which identifies the traveler's room number in the place of lodging, the space number where the rental vehicle is located, and even a number of the vehicle.

From the point of view of the vendor, in addition to the above-mentioned savings in personnel, equipment, and real estate or rental costs, the invention can entirely eliminate the need for a front desk and rental agency counter while greatly improving customer satisfaction. In addition, because of the time savings afforded the traveler, the place of lodging/rental car vendor may be located further from the airport terminal, with resulting savings in rents and airport fees.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. A method of providing lodging and vehicle rentals for travelers, said lodging including rooms and parking spaces associated with said rooms, comprising the steps of:
providing a vehicle in a parking space associated with a room;
accepting a common reservation for said room and said parking space;
providing transportation from a common carrier arrival point to said lodging;
accepting payment at said room for both said room and said vehicle; and
granting access to said room and said vehicle following said payment.

2. A method as claimed in claim 1, wherein said common carrier arrival point is an airport, said transportation is a shuttle bus or van, and said lodging is located away from said airport.

3. A method as claimed in claim 1, wherein said step of accepting payment comprises the steps of having the traveler insert a payment card in a card reader situated in or adjacent a door to said room, charging the payment card or debiting an account belonging to the traveler.

4. A method as claimed in claim 3, wherein the step of enabling access to the room comprises the step of unlocking a door to the room upon receiving said payment.

5. A method as claimed in claim 4, wherein the step of enabling access to the room further comprises the step of providing car keys within said room or retrieval by the traveler after the door has been unlocked.

6. A method as claimed in claim 4, further comprising the steps of:
enabling check-out from said room by accepting said payment card for final payment; and
printing, using a printer situated in said room, a receipt detailing final charges.

7. A method as claimed in claim 1, wherein registration is required prior to pick-up by said transportation.

8. A method as claimed in claim 7, further comprising the step of requested a credit card and valid driver's license number from the traveler during registration.

9. A method as claimed in claim 1, further comprising the step of checking a driver's identity and confirming that the car has been rented whenever one of said rental cars is driven from said parking space away from said lodging.

10. A method as claimed in claim 1, wherein said lodging provides additional amenities commensurate with those provided by hotels and motels.

11. A method as claimed in claim 1, further comprising the step of selling gasoline to travelers at a gas pump provided adjacent said lodging.

12. A method as claimed in claim 1, further comprising the step of cleaning and maintaining said vehicles between rentals while said vehicles are parked in said parking spaces.

13. A method of providing lodging and vehicle rentals for travelers, comprising the step of providing said lodging and vehicle rentals at a single location accessible to a traveler by a single shuttle ride.

14. A method of providing lodging and vehicle rentals to a traveler, comprising the steps of accepting, at a room to be rented, payment for both said room and a vehicle parked in a parking space associated with said room.

15. A method of operating a vehicle rental agency, comprising the step of storing and maintaining said vehicles during periods between rentals in parking spaces associated with hotel or motel rooms, and accepting common payment for said vehicles and said rooms.

16. A method as claimed in claim 15, further comprising the step of requiring registration for said vehicles and said rooms prior to transportation to said rooms.

17. A method as claimed in claim 16, further comprising the step of requested a credit card and valid driver's license number from the traveler during registration.

18. A method as claimed in claim 15, further comprising the step of checking a driver's identity and confirming that the car has been rented whenever one of said rental cars is driven from said parking space away from said lodging.

19. A method as claimed in claim 15, further comprising the step of selling gasoline to travelers at a gas pump provided adjacent said lodging.

20. A method of operating lodging, comprising the step of providing, in parking spaces associated with rooms for rent, vehicles that are rented upon rental of said rooms.
